(19) United States
(12) Patent Application Publication
(10) Pub. No.: US 2026/0159362 A1
(43) Pub. Date: Jun. 11, 2026

(54) SYSTEM FOR ALIGNMENT OF JIB TO CRANE

(71) Applicant: Custom Truck One Source, Inc., Kansas City, MO (US)

(72) Inventors: Zach Minor, Kansas City, MO (US); Kyle Gerber, Kansas City, MO (US)

(21) Appl. No.: 18/970,230

(22) Filed: Dec. 5, 2024

(51) Int. Cl. B66C 23/68

(52) U.S. Cl. CPC B66C 23/68; B66C 2700/03

(57) ABSTRACT

A system for aligning a jib for attachment to a crane boom head, the boom head comprising a plurality of attachment points and a jib framework with a plurality of secondary attachment points. The jib framework includes a first and second side and a plurality of attachment points for securing the first and second sides of the jib framework to the boom head attachment points. The system also includes first and second shells with a plurality of axle mounted sheaves as well as a first rope a second rope. The system includes a drive assembly for independently adjusting the location of the secondary attachment points of the jib framework for alignment with the primary attachment points of the boom head.

### FIELD OF THE DISCLOSURE

A system for positioning and aligning a crane jib with a boom head of a crane for attachment purposes.

### BACKGROUND

A crane jib, also known simply as a jib or a crane arm, is an extended horizontal or angled beam attached to the main crane body. It protrudes beyond the crane's main structure and typically has a hoist and trolley mechanism mounted on it. A crane jib is designed to extend the reach and versatility of a crane. It consists of a sturdy beam that can be fixed at an angle or can be adjustable to various positions. The end of the jib often has a hook or other lifting device attached to facilitate the lifting and maneuvering of loads.

There are different types of crane jibs based on their configuration and purpose to include a rigid extension fixed at a specific angle to the crane's main structure. A luffing jib is an adjustable jib that can be raised or lowered to change its angle relative to the crane.

The primary function of a crane jib is to extend the reach of the crane beyond its normal lifting capability. This is particularly useful in construction sites where specific points need to be reached without repositioning the entire crane. Jibs allow for more precise maneuvering of loads, especially in congested or confined spaces where the main crane body might not have direct access.

Depending on the type and design, jibs can be used for various lifting tasks, from heavy construction materials to delicate operations requiring precise control. Crane jibs are commonly used in construction, shipyards, warehouses, and manufacturing facilities. They play a crucial role in lifting heavy materials such as steel beams, concrete panels, machinery, and more. In essence, a crane jib enhances the operational flexibility and efficiency of a crane by extending its reach and providing additional lifting capabilities in diverse working environments.

While cranes are extremely useful, a jib expands the already considerable repertoire of tasks that the combined crane-jib system can address. Nonetheless, when securing a jib to a crane boom head the process of aligning and securing the attachment points of a jib to a crane is typically a very challenging process. Ensuring that the attachment points on both the crane and the jib align perfectly in terms of dimensions and geometry generally is not easily accomplished. The reasons for these challenges are numerous to include the boom head does not retract to the same position after each use and the jib stowage brackets move during transport.

Additionally, the pins used to secure the jib clevis brackets that overlap and engage with the tangs extending outwardly from the boom head are oftentimes driven into the clevis brackets and tangs manually with a heavy hammer to achieve alignment and attachment. The heavy hammer impacts upon the heads of the pins tends to deform (mushroom) the head of the pin as well as the shaft of the pin and the openings in the clevis brackets. Importantly, there is no optimal location on the jib or the boom head that is convenient for positioning a person using a pry bar for deploying or stowing the jib. The fourth pin to be installed is particularly challenging as the jib clevis holes are generally considerably misaligned with the openings in the tangs of the boom head due to the weight of the jib causing deflection in the structure. Consequently, the task of deploying and stowing the jib is very physically intensive and time consuming.

Alternative means of alignment of the jib clevis brackets with the openings in the tangs is to position the distal end of the jib at ground level to support the weight of the jib and facilitate installation of the fourth pin. This procedure allows for incremental downward movement of the boom to accommodate placement of the fourth pin into the clevis bracket for passage through the boom head tang. This of course requires that there be sufficient ground level space available to accommodate the extensible boom as well as the jib.

Another option is to position the jib atop a kick stand to support the weight of the jib to facilitate alignment. Also, using a winch to incrementally lift the jib requires another extensible boom or similarly capable equipment and is therefore costly and time consuming. Lastly, utilization of bottle jack or porta power can facilitate alignment but these devices only help position for the fourth pin. These devices do not help with installation and alignment of the first two pins.

The principal challenge with the traditional jib alignment and attachment procedure is that connection with pins is over constrained.

### SUMMARY

The jib to crane alignment system yield is a system for attachment of a jib to a crane. The boom head of the crane is disposed at a distal end of the crane and includes a plurality of attachment points for mounting the jib to the crane. The system disclosed herein also includes a jib framework. The jib framework includes a first and second side and a plurality of attachment points at a proximal end of the jib framework for securing the first and second sides of the jib framework to the boom head.

The system also includes a first and second set of sheaves with each set of sheaves disposed within a first and second shell with the first and second shells replicated on the first and second sides of the jib framework. At least one rope is reeved through the first and second set of sheaves per side of the jib framework to increase the mechanical advantage available to the system on both sides. Each of the ropes includes a first end and a second end, the first end being anchored to the jib framework.

The motive power for the system comes from a drive assembly for rotating a drive shaft extending between the first and second sides of the jib framework. The drive shaft includes a first and second end. While the ropes and sheaves are not directly driven by the drive shaft this system includes a first and second opposed rotatable tensioning members. The rotatable tensioning members are coaxial with the axis of rotation of the drive shaft. The tensioning members are positioned outwardly from the drive assembly and include a first and second end. The first end of each rotatable tensioning member is mounted to a support member on the jib framework. The second end of each rotatable tensioning member includes a drive member to facilitate engagement with the drive shaft.

The system also includes first and second slip collars that are independently operable to selectively transfer rotational motion from the drive shaft to the respective drive member for rotation of the rotatable tensioning member to which the second end of the rope is attached for purposes of adjusting the tension in the rope.

It is an object of the system disclosed herein to expedite the attachment of a jib to a boom head of a crane.

It is a further object of the system disclosed herein to reduce the physical effort required to attach a jib to a boom head of a crane.

It is a further object of the system disclosed herein for operational purposes to provide a quick means of offsetting the jib from the boom head of a crane.

It is a further object of the system disclosed herein to minimize damage to attachment hardware by improving the ease of alignment of the attachment fixtures on the boom head and the jib.

Various objects, features, aspects, and advantages of the disclosed subject matter will become more apparent from the following detailed description of preferred embodiments, along with the accompanying drawings in which like numerals represent like components. The contents of this summary section are provided only as a simplified introduction to the disclosure and are not intended to be used to limit the scope of the appended claims.

The contents of this summary section are provided only as a simplified introduction to the disclosure and are not intended to be used to limit the scope of the appended claims.

### BRIEF DESCRIPTION OF THE DRAWINGS

FIG. 1 illustrates a perspective view of a jib positioned adjacent a crane with a boom head;

FIG. 2 illustrates a side elevation view of the jib and crane as initially illustrated in FIG. 1;

FIG. 3 illustrates a perspective view of an embodiment of the system for alignment and attachment of a jib to a boom head;

FIG. 4 illustrates another perspective view of an embodiment of the system for alignment and attachment of a jib to a boom head;

FIG. 5 illustrates yet another perspective view of an embodiment of the system for alignment and attachment of a jib to a boom head;

FIG. 6 illustrates an embodiment of the drive assembly of the disclosed system;

FIG. 7 illustrates a section view of the drive assembly and support members of the disclosed system;

FIG. 8 illustrates another perspective view of an embodiment of the system for alignment and attachment of a jib to a boom head;

FIG. 9 illustrates another perspective view of an embodiment of the system for alignment and attachment of a jib to a boom head;

FIG. 10 illustrates a front elevation view of an embodiment of the system for alignment and attachment of a jib to a boom head;

FIG. 11 illustrates a perspective view of an embodiment of a slip collar disengaged from a drive collar;

FIG. 11A illustrates a section view of the drive assembly and bushings utilized along the drive shaft;

FIG. 12 illustrates a perspective view of an embodiment of a slip collar engaged with a drive collar;

FIG. 13 illustrates a front elevation view of an embodiment of the drive assembly with the left slip collar engaged with the drive collar and the right slip collar disengaged from the drive collar;

FIG. 14 illustrates an elevation view of an embodiment of the drive assembly including both slip collars disengaged from their respective drive collars;

FIG. 15 illustrates an embodiment of a locking pawl assembly preventing rotation in a single direction of the locking gear;

FIG. 16 illustrates a 0-degree offset of the jib from the crane;

FIG. 17 illustrates a 15-degree offset of the jib from the crane;

FIG. 18 illustrates a 30-degree offset of the jib from the crane; and

FIG. 19 illustrates a jib framework and boom head with an indicator of the six degrees of freedom.

### DETAILED DESCRIPTION

The disclosed apparatus, and systems should not be construed as limiting in any way. Instead, the present disclosure is directed toward all novel and nonobvious features and aspects of the various disclosed embodiments, alone and in various combinations and sub-combinations with one another. The disclosed apparatus and systems are not limited to any specific aspect or feature or combination thereof, nor do the disclosed embodiments require that any one or more specific advantages be present, or problems be solved.

In view of the many possible embodiments to which the principles of the disclosed invention may be applied, it should be recognized that the illustrated embodiments are only examples of the disclosure and should not be taken as limiting the scope of the invention. Rather, the scope of the invention is defined by the following claims. We therefore claim as our invention all that comes within the scope of these claims.

The disclosure presented herein is believed to encompass at least one distinct invention with independent utility. While the at least one invention has been disclosed in exemplary forms, the specific embodiments thereof as described and illustrated herein are not to be considered in a limiting sense, as numerous variations are possible. Equivalent changes, modifications, and variations of the variety of embodiments, materials, compositions, and methods may be made within the scope of the present disclosure, achieving substantially similar results. The subject matter of the at least one invention includes all novel and non-obvious combinations and sub-combinations of the various elements, features, functions and/or properties disclosed herein and their equivalents.

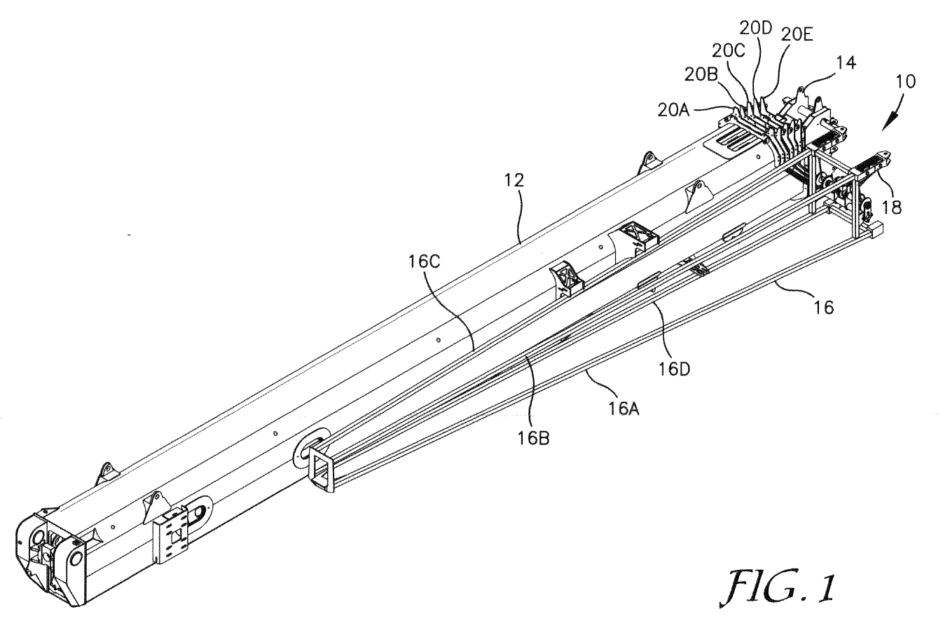

FIG. 1 illustrates the components of the disclosed system 10 to include a crane 12 with a boom head 14 and a jib 16 with a jib framework 18 to facilitate attachment of the jib framework 18 to the boom head 14 of the crane 12. While jibs can vary in configuration a common form of jib, as further illustrated at FIG. 1 includes a plurality of outwardly extending strut members 16A, 16B, 16C and 16D. The jib strut members extend the overall reach of the system 10 that includes the jib 16, jib framework 18, crane 12 and boom head 14. As is further detailed in this disclosure, the system 10 also facilitates overreach of a stationary object, such as a building, by offsetting of the jib. This offsetting attribute allows flexibility in positioning of the combined system when lifting loads such that the system 10 can be positioned close to a building over which it is lifting a load due to the ability of the jib to be offset downward, for example, by 30 degrees.

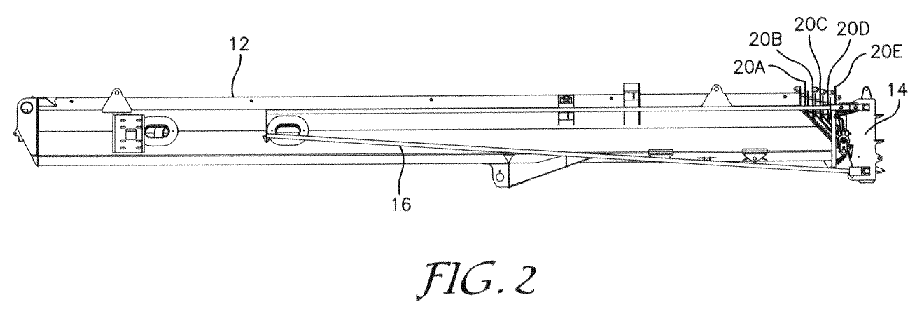

The crane 12, as illustrated at FIGS. 1 and 2 includes a series of nested sections 20A-20E that extend in a telescoping manner typically with motive power supplied by an internally disposed hydraulic cylinder (not shown). The total number of nested boom sections can vary by crane vendor, make and model; however, it is quite common for there to be at least three nested sections.

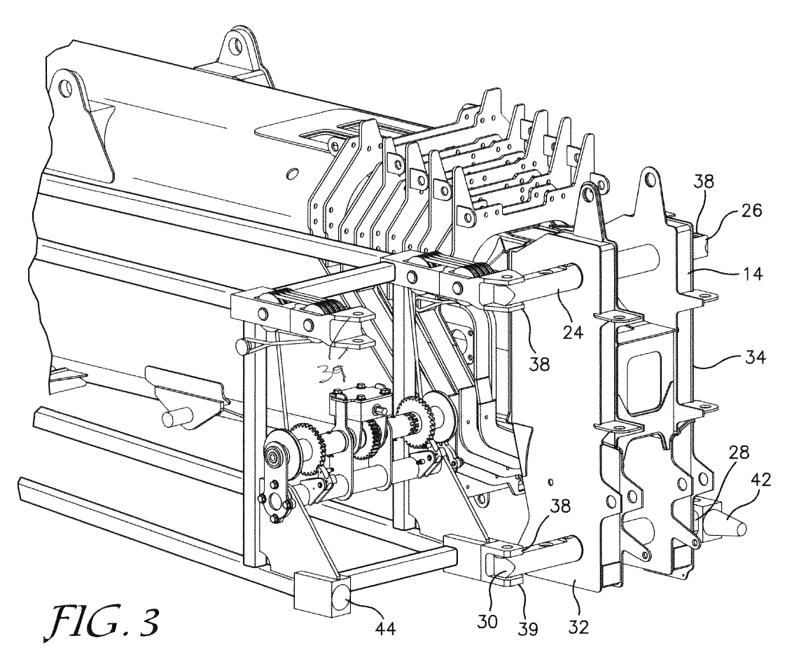

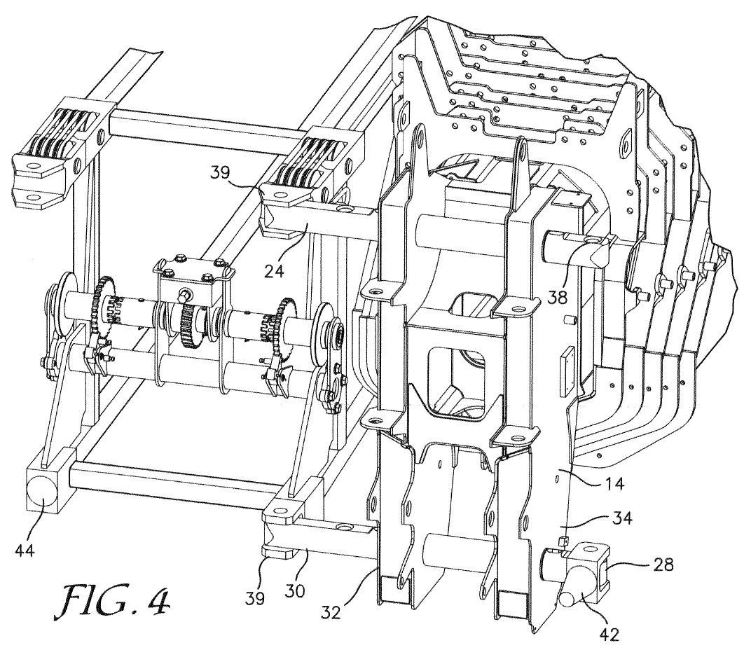

At the distal end of the outermost nested section 20E, as illustrated at FIG. 2 is the boom head 14 of the crane 12. The boom head 14 is a robustly constructed fixture utilized for attachment to the jib framework 18. The boom head 14 typically includes a plurality of primary attachment points. In a preferred embodiment, as illustrated at FIGS. 3 and 4, a total of four primary attachment points is contemplated. A form of attachment point that is contemplated by this disclosure are posts 24, 26, 28, 30 extending outwardly from the first and second side walls 32, 34 of the boom head 14. The posts preferably pass through at least one side wall 32, 34 and preferably both walls and include the capacity to rotate. At the outer end of the posts are through holes 38 that facilitate the passage of a pin (not shown) through the flanges 39 of the jib framework 18 as is discussed in greater detail below.

The primary attachment points 24, 26, 28, 30 of the boom head 14 are mounted to the secondary attachment points 40A, 40B, 40C, 40D of the jib framework formed preferably by opposed flanges 39, as shown at FIGS. 3 and 4, for restraining the primary attachment point posts 24, 26, 28, 30. A configuration that greatly facilitates the process of attaching the jib framework 18 to the boom head 14 is the use of cones 42 mounted at the outer end of one or more of the posts 24, 26, 28, 30. As illustrated at FIGS. 3 and 4, the cones 42, which are preferably truncated, are configured for receipt into secondary attachment point sockets 44 that are mounted to the jib framework 18. The cones 42 and sockets 44 are especially useful when the two 42, 44 are not coaxially aligned. The outer opening of the socket 44 is larger than the smallest diameter of the cone 42. Due to the complex structure of the jib framework 18, particularly under the loads imposed by the jib framework itself, there can be misalignment of the cone 42 and the socket 44. This misalignment scenario arises often when attempting to attach jib frameworks 18 to boom heads 14. Nonetheless, the socket 44 can accept the cone 42 and drive the cone to proper alignment as the cone traverses inwardly on the socket 44 due to the angled walls of the socket.

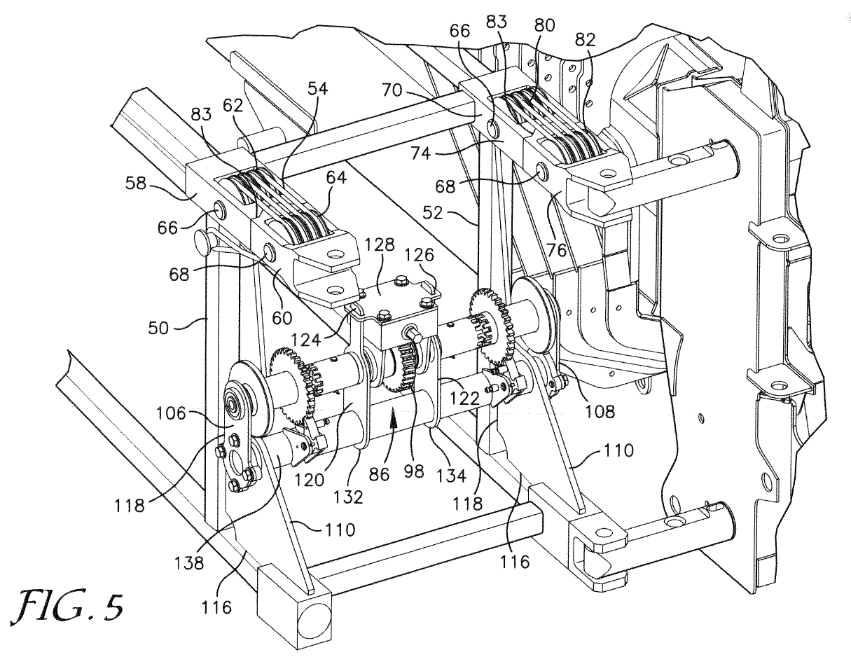

FIG. 5 further illustrates the jib framework 18 that includes a first side 50 and a second side 52 of the framework. A preferred embodiment of the framework 18 on the first side 50 includes a sheave set 54. Each sheave set 54 of the preferred embodiment consists of two shells 58, 60. Each shell 58, 60 restrains a plurality of sheaves 62, 64 that are mounted to axles 66, 68 thereby facilitating the rotation of the sheaves. A preferred embodiment of the disclosed system utilizes four sheaves 62, 64 in each shell 58, 60; however, a greater or lesser number of sheaves in a sheave set 54 is contemplated by this disclosure.

In a preferred embodiment, the second side 52 of the framework 18, as with the first side 50, includes a sheave set 70. Each sheave set of the preferred embodiment consist of two shells 74, 76. Each shell 74, 76 restrains a plurality of sheaves 80, 82 that are mounted to axles 66, 68 thereby facilitating the rotation of the sheaves. A preferred embodiment of the disclosed system utilizes four sheaves 80, 82 in each shell 74, 76; however, a greater or lesser number of sheaves in a sheave set 70 is contemplated by this disclosure.

The first 58, 74 and second 60, 76 shells on both the first 50 and second 52 sides are separable from one another, such as when the jib undergoes an offset as is discussed in greater detail below. However, when in contact with one another the first and second shells rely upon an interlocking embedded engagement 83 of the shells to prevent lateral movement relative to one another.

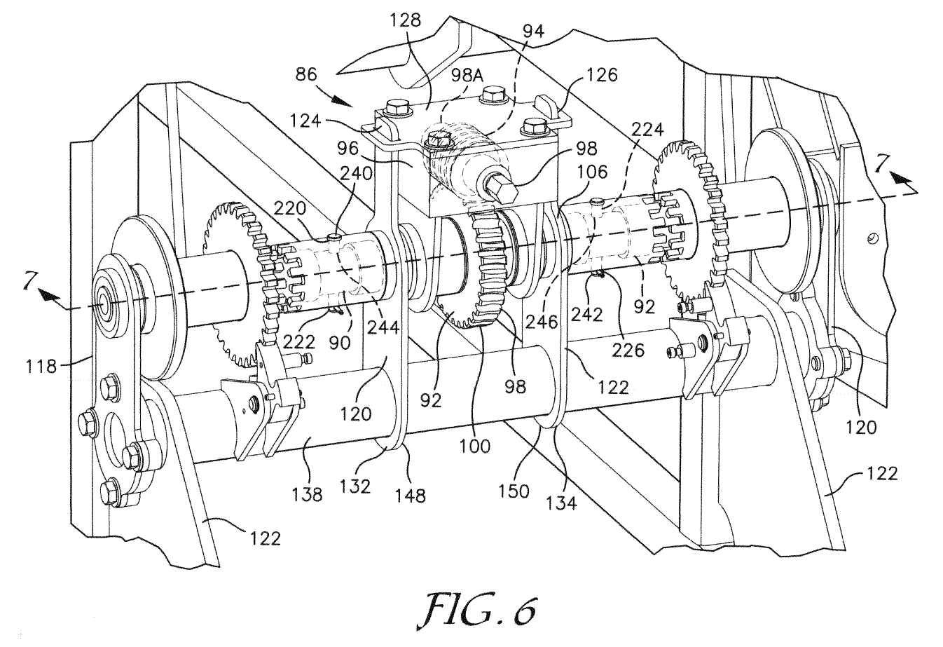

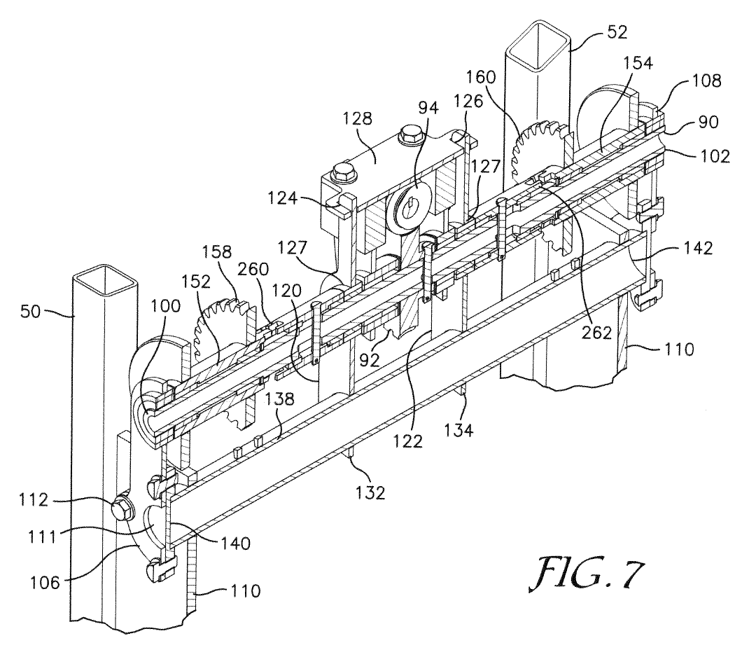

As illustrated at FIGS. 5 and 6, the system 10 as disclosed herein includes a drive assembly 86 disposed laterally central within the jib framework 18 and beneath the sheave sets 54, 70. As illustrated at FIG. 6, the disclosed system 10 includes a drive assembly 86 and a drive shaft 90. The drive shaft 90 is internal to the system as is illustrated at FIG. 6 as well as in the sectional view of FIG. 7. A worm gear 92 is mounted to the drive shaft 90 and the worm gear 92 is rotated by a worm screw 94 with a proximal end 98 and a distal end 98A. The worm gear 92 and worm screw 94 are positioned within a housing 96 that serves to restrain in position the worm screw 94. As illustrated at FIG. 6, the proximal end 98 and distal end 98A of the worm screw 94 serve as points of engagement, e.g., a hex head, for a rotary tool (not shown) to reversibly rotate the worm screw 94 and in turn rotate the worm gear 92.

As illustrated at FIG. 7, the drive shaft 90 has first and second ends 100, 102 located at the opposed sides 50, 52 of the jib framework 18. The drive shaft 90 is supported at the opposed first and second ends 100, 102 by brackets 106, 108 that are mounted to stiffener plates 110 with threaded fasteners 112 on both sides 50, 52 of the jib framework 18. The stiffener plates 110 are secured to the jib framework 18 preferably by welding to the jib framework 18 at two edges 116, 118, as best illustrated at FIG. 5. However, the use of threaded fasteners for securing a variant of the stiffener plates 110 to the jib framework 18 is also contemplated by this disclosure.

As also illustrated at FIGS. 5 and 6, additional support members 120, 122 are also incorporated on each side of and proximate the housing 96. These support members 120, 122 extend downwardly from slots 124, 126 in the housing cover plate 128 and provide an opening 127, on both sides, for the drive shaft 90 to pass through as again best seen at FIG. 7. After circumscribing the drive shaft 90 the distal ends 132, 134 of the support members 120, 122 circumscribe a primary support member 138 that spans between the first and second sides 50, 52 of the jib framework 18. As illustrated at FIG. 7, the opposing ends 140, 142 of the primary support member 138 are preferably supported by the same stiffener plates 110 that support the drive shaft 90 as described above. The opposing ends 140, 142 preferably extend through the stiffener plates 110 and into an opening 111 in each of the brackets 106, 108 thereby providing enhanced support for the primary support member 138.

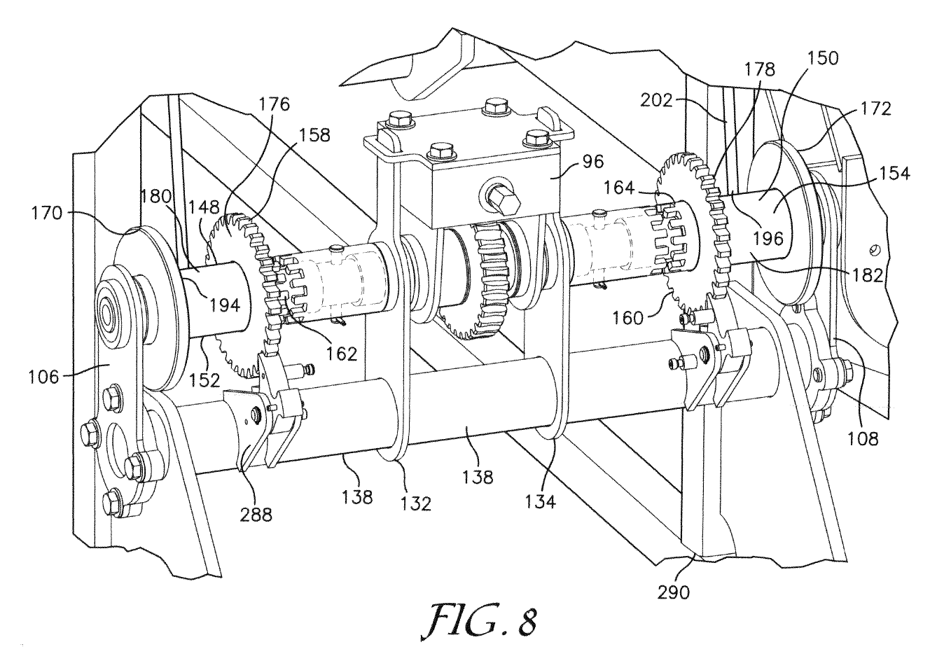

As illustrated at FIG. 8, mounted outboard of the housing 96 on each side are first and second rotatable tensioning members 148, 150. The rotatable tensioning members each utilize a tubular member 152, 154 that are coaxial with and surround or envelop the drive shaft 90 again as best illustrated at FIG. 7. Locking gears 158, 160 are axially mounted to the tubular members 152, 154. Adjacent to the locking gears 158, 160 mounted to the tubular members 152, 154 and facing inboard toward the drive housing 96 are toothed drive collars 162, 164. The toothed drive collars are affixed to the locking gears 158, 160 so that rotation of the toothed drive collars 162, 164 results in rotation of the of the tensioning members 148, 150 to include the associated locking gears 158, 160.

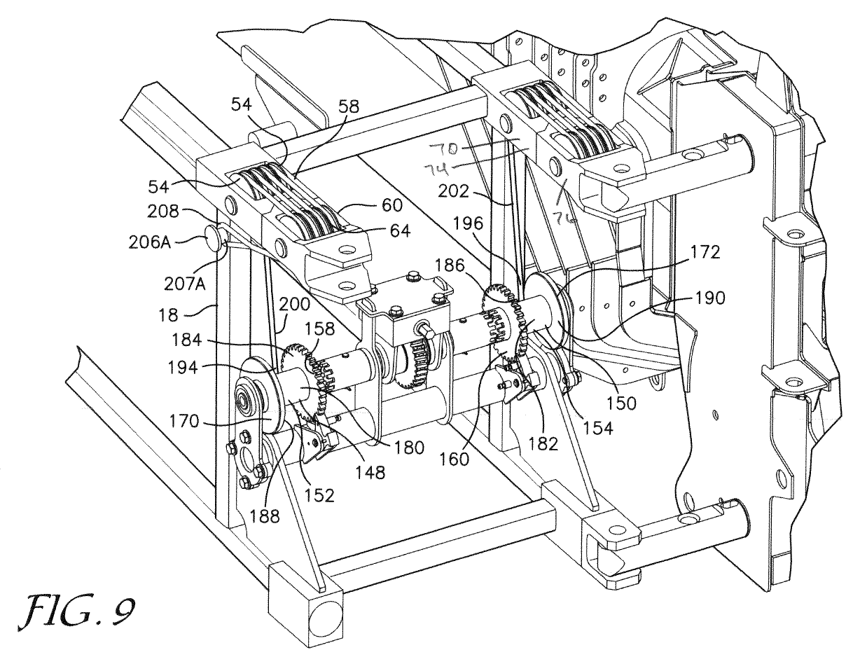

The outer drum flanges 170, 172, as illustrated in FIG. 8 are spaced apart by at least several inches, and in various embodiments a greater distance, from the outboard side 176, 178 of the locking gears 158, 160 and are disposed proximate the brackets 106, 108 that solidly anchor the drive shaft 90 to the jib framework 18. As illustrated at FIG. 9, the surface area 180, 182 of the tensioning members 148, 150 on the tubular members 152, 154 between the outboard side 184, 186 of the locking gears 158, 160 and the inner face 188, 190 of the outer drum flanges 170, 172 is where the second ends 194, 196 of the tensioning ropes 200, 202 are anchored. The second ends 194, 196 are anchored to the surface area 180, 182 with standard hardware for anchoring the ends of wire rope and the hardware is well known in the industry. Additionally, as the tubular members 152, 154 of the rotatable tensioning members 148, 150 are rotated by the drive assembly 86 a portion of each tensioning rope 200, 202 is either wrapped around or unwrapped (depending upon rotation direction) from the tubular members 152, 154 resulting in either an increase or decrease in the tension upon the applicable rope 200, 202.

The ropes 200, 202 are central to the functionality of the disclosed system 10. As illustrated at FIG. 9, the first ends 208 of the ropes 200, 202 are secured to the jib framework 18 on riser T-posts 206A on both sides of the jib framework 18. In a preferred embodiment, a loop 207A is formed at the first ends 208 of the ropes 200, 202 and secured to the T-posts 206A to securely anchor the ropes to the jib framework 18. Moving away from the first ends 208, the ropes 200, 202 are reeved through the sheaves 62, 64, 80, 82.

Importantly, the first and second rotatable tensioning members 148, 150 to include the tubular members 152, 154 the toothed drive collars 162, 164, the locking gears 158, 160 and the outer drum flanges 170, 172 circumscribe the drive shaft 90 but are not continuously driven by the drive shaft 90. The drive shaft 90 is axially aligned with the tubular members 152, 154 and rotates internal to the tubular members 152, 154. The methodology for engaging rotary motion of these rotatable tensioning member 148, 150 components is the function of the two slip collars 210, 212.

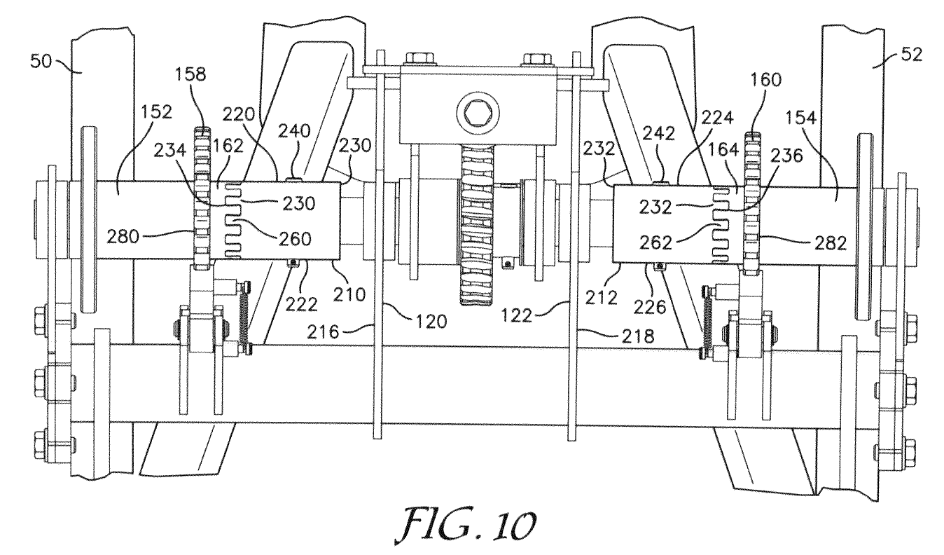

The slip collars 210, 212, as illustrated at FIG. 10, are utilized on both sides 50, 52 of the jib framework 18, circumscribe the drive shaft 90 and occupy only a portion of the span between the outboard faces 216, 218 of the support members 120, 122 and the toothed drive collars 162, 164. The slip collars 210, 212 each include two through holes 220, 222, 224, 226 that are preferably spaced apart by about 180 degrees and are disposed approximately mid-longitudinal span. As best illustrated at FIGS. 6 and 10, pins 240, 242 are passed through the first opening 220, 224 on each slip collar, through longitudinally extending slots 244, 246 in the drive shaft 90 and then through the second opening 222, 226 on each slip collar. Because the pins 240, 242 pass through the longitudinally extending slots 244, 246 they are forced to turn with the drive shaft 90 and interfere with the edges of the through holes 220, 222, 224, 226 resulting in the rotation of the drive shaft 90 being transferred to the slip collars 210, 212.

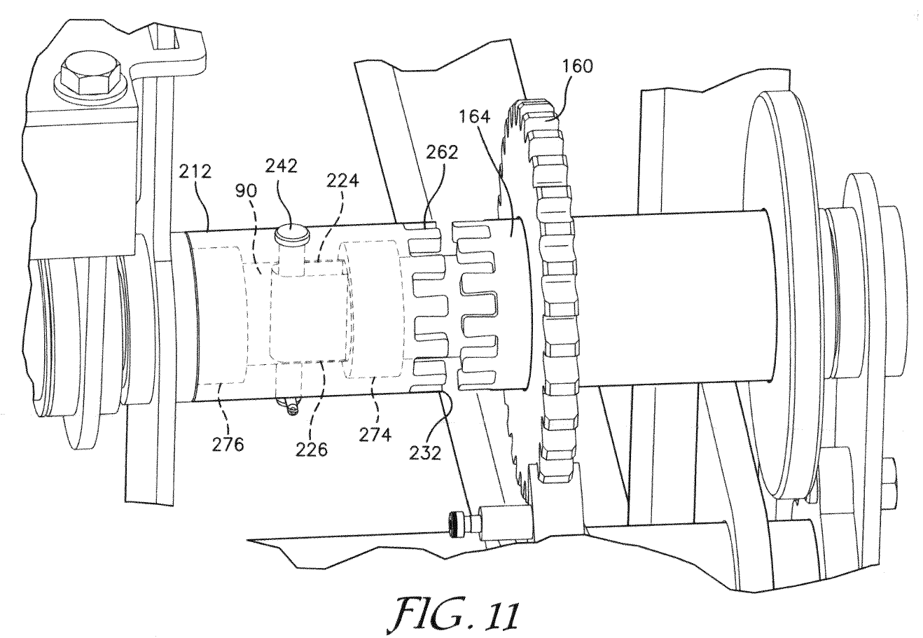

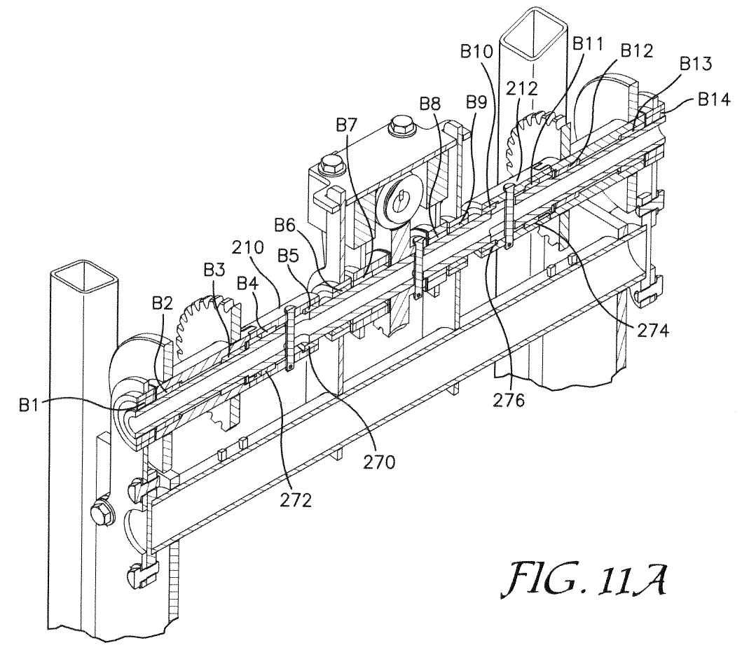

As illustrated at FIGS. 6 and 10, the longitudinally extending slots 244, 246 provide the slip collars 210, 212 with the capability to connect and disconnect from the engagement members 260, 262 of the first ends 230, 232 of the slip collars to the toothed drive collars 162, 164 of each of the rotatable tensioning members 148, 150. To initiate rotation of the rotatable tensioning members 148, 150, the slip collars 210, 212 are preferably manually slid outward (away) from the drive housing 96 for receipt of the slip collar engagement members 260, 262 into the drive collars 162, 164. This is best illustrated by the contrasting views shown in FIGS. 11 and 12 showing respectively disengagement and then engagement of one of the slip collars 212 with its respective drive collar 164. The longitudinally extending slots 244, 246 allow the slip collars 162, 164 to translate laterally along the axial path of the drive shaft 90 until the pins 240, 242 interfere with the ends of the slots 244, 246 thereby preventing further translation.

The pins 240, 242 are strategically positioned to transect the drive shaft 90 to facilitate full receipt of the first ends 230, 232 of the toothed engagement members 260, 262 into the toothed drive collars 162, 164 thereby ensuring on-demand rotation of the rotatable tensioning members 148, 150. On-demand rotation is provided, for example, by using a rotary tool that is capable of bi-directional rotation of the proximal end 98 or distal end 98A of the worm screw 94. Importantly, the slip collars 162, 164 can be simultaneously engaged thereby altering tension on both ropes 200, 202 or the operator can engage only a single collar at any time to alter the position primarily of that side's attachment points.

As illustrated at FIGS. 11 and 11A, each of the slip collars 210, 212 also utilizes a pair of sleeve bearings 270, 272, 274, 276 to maintain the concentricity, or axial alignment, of the slip collars with the drive shaft 90 during translation of the slip collars into or out of toothed engagement with the respective drive collar 162, 164. The sleeve bearings 270, 272, 274, 276 are press fit into their respective components such as the slip collars 210, 212 and slip fitted onto the drive shaft 90. FIG. 11A partially illustrates an embodiment of the system 10 with a total of fourteen bushings B1-B14 slip fit onto the shaft 90. Referring again to FIG. 11, the bushings 274, 276 provide for a near frictionless translation of the slip collar 212 along the drive shaft, the same being the case for slip collar 210 with its own bushings 270, 272. For example, as illustrated at FIGS. 11A and 12, the bushings 270, 272, 274, 276 allow for axial translation of the first ends 230, 232 of the slip collars 210, 212 into engagement with the drive collars 162, 164 and facilitate alignment of both ends of each slip collar as they are translated back and forth (in and out of engagement with the toothed drive collars 162, 164) along the drive shaft 90.

To counteract forces applied to the tensioning ropes 200, 202 by the drive assembly 86 and prevent reversal of the rotational movement of the tensioning members 148, 150, a pair of locking gears 158, 160 are utilized as illustrated at FIG. 10. The locking gears are mounted proximate the inboard edges 280, 282 of the tubular members 152, 154 of the tensioning members 148, 150. The locking gears 158, 160 while axially aligned with the drive shaft 90 are operable to remain stationary or rotate with the drive shaft 90 when the drive shaft rotates.

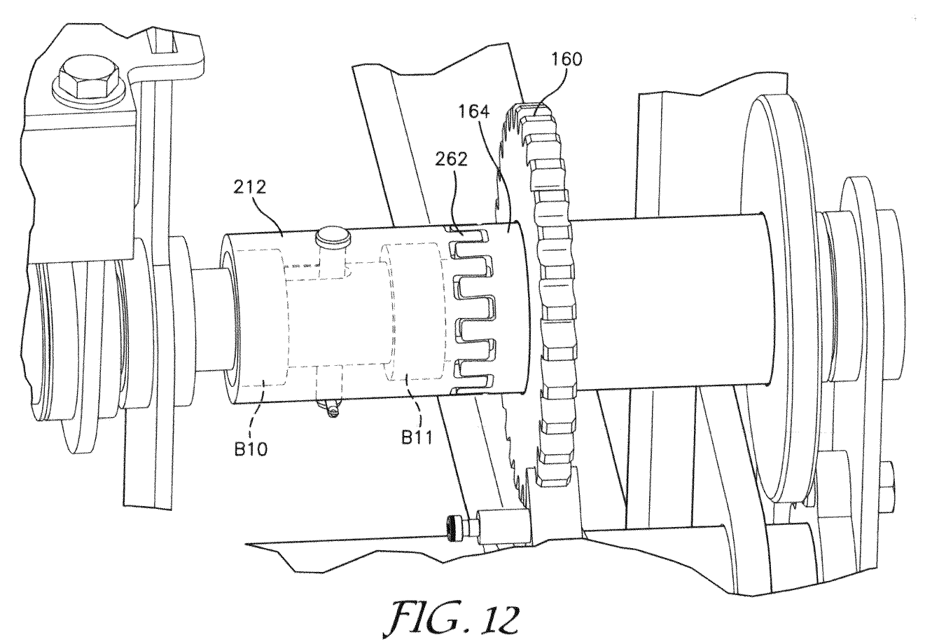

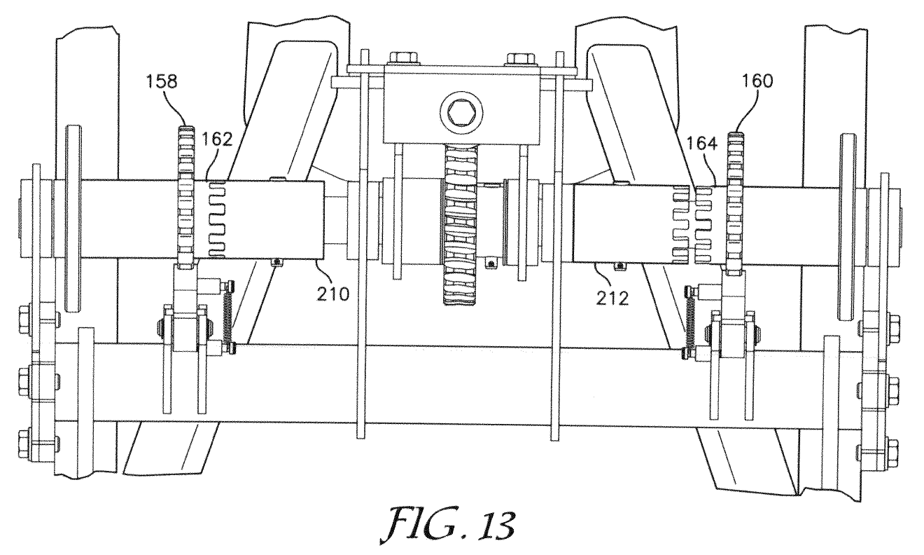

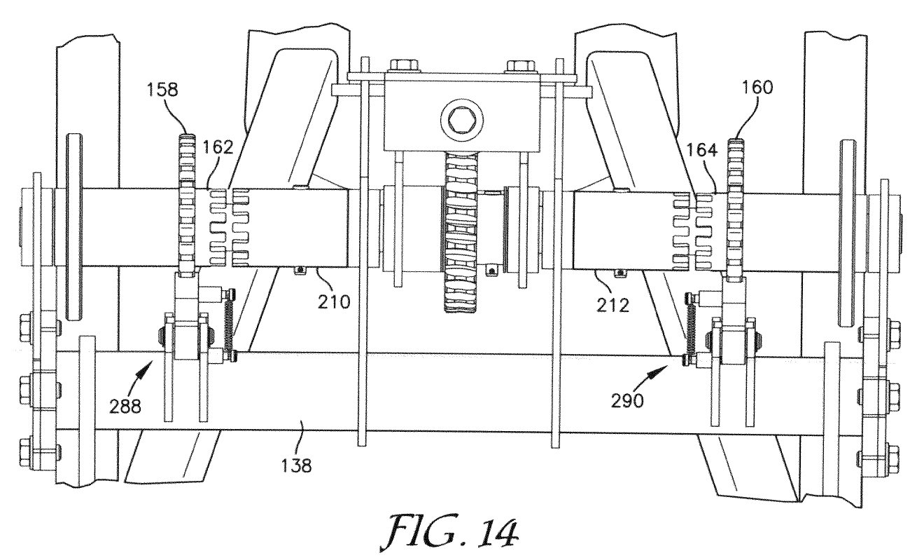

As best illustrated at FIG. 7, the drive shaft 90 is disposed internal to the tubular members 152, 154 and, as discussed above, the locking gears 158, 160 do not rotate unless the engagement member 260, 262 of the applicable slip collar 210, 212 is received into the applicable toothed drive collar 162, 164. FIG. 12 illustrates the slip collar 212 as being fully engaged with the drive collar 164. FIG. 13 illustrates the first (left) slip collar 210 as being fully engaged with the drive collar 162 while the second (right) slip collar 212 is fully disengaged from the drive collar 164. FIG. 14 illustrates both slip collars 210, 212 with the left slip collar 210 being fully disengaged from the associated drive collar 162 and the right slip collar 212 also being fully disengaged from its associated drive collar 164.

Lacking engagement between the slip collar and the drive collar, the locking gears 158, 160 are not configured to rotate with the drive shaft 90. The locking gears are preferably spur gears with a rectangular tooth profile and of a gear diameter in the range of 4 to 8 inches; however, the gear diameter may be larger, or smaller, depending upon the anticipated load carried by the locking gears 158, 160.

As illustrated at FIG. 14, extending outwardly from and mounted to the primary support member 138 are biased retractable pawl assemblies 288, 290 for engagement with each locking gear 158, 160. The pawl assemblies 288, 290 are configured to allow rotation of the locking gears in a single direction and prevent rotation of the locking gears in the opposite direction which may cause a reduction in the tension on the ropes 200, 202. The pawl assemblies are biased, using for example springs, to apply pressure to the teeth of the locking gears 158, 160 and can be manually retracted to facilitate rotation of the locking gears in the direction of rotation prevented by the pawl assemblies.

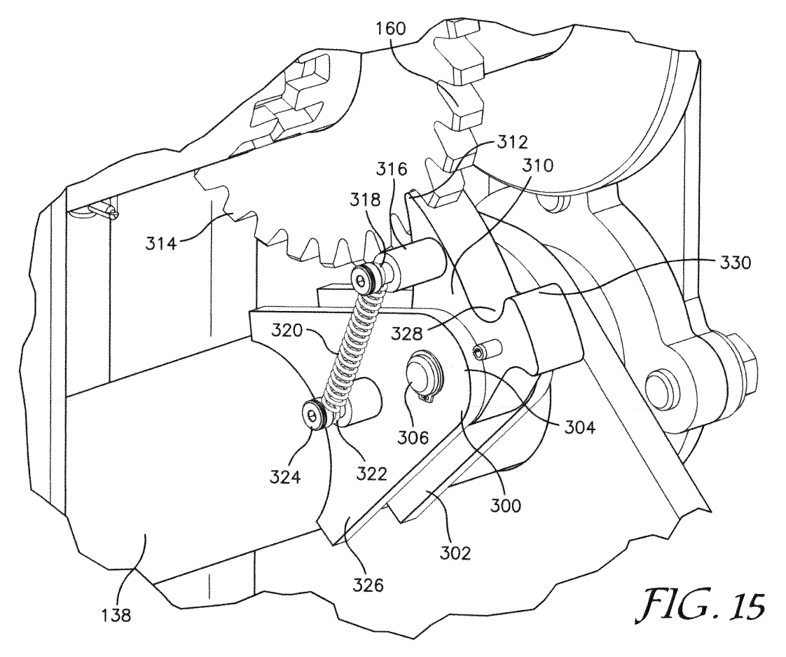

In a preferred embodiment as illustrated at FIG. 15, bracket pairs 300, 302 are rigidly secured to the primary support member 138 proximate each of the locking gears 158, 160. The triangular shaped bracket pairs 300, 302 converge toward a radiused end 304 and adjacent the radiused end 304 is a pivot shaft 306 passing through the bracket pairs 300, 302. The pivot shaft 306 extends between the bracket pairs and passes through the pawl member 310 that is disposed between the bracket pairs 300, 302 restraining the pawl member between the bracket pairs 300, 302. A locking edge 312 of the pawl member 310 is operable for engagement with the teeth 314 of the locking gears 158, 160. This locking edge 312 serves to restrain movement of the locking gears 258, 160 until it is retracted.

In a preferred embodiment, the pawl assemblies 288, 290 utilize an outwardly extending post 316 proximate the locking edge 312 for attachment of a first end 318 of a spring 320. The second end 322 of the spring 320 is secured to a post 324 mounted to the exterior face 326 of the bracket pair member 300. The pawl member 310 also preferably includes a trough 328 and ledge 330 for the application of finger or tool pressure to retract the locking edge 312 of the pawl from engagement with the teeth 314 of the locking gears 158, 160.

As illustrated at FIGS. 9 and 11, the second ends 194, 196 of the tensioning ropes 200, 202 are anchored to the tubular members 152, 154 of the tensioning members 148, 150 between the outboard side 184, 186 of the locking gears 158, 160 and the inner face 188, 190 of the outer drum flanges 170, 172. If one or more of the slip collars 210, 212 are engaged with the drive collars 162, 164 then the tubular members 152, 154 are subject to rotation if a rotary tool is rotating at the drive assembly 86. The rotation of the tubular members 152, 154 results in the tensioning ropes 200, 202 either being further wrapped or unwrapped from the tubular members 152, 154.

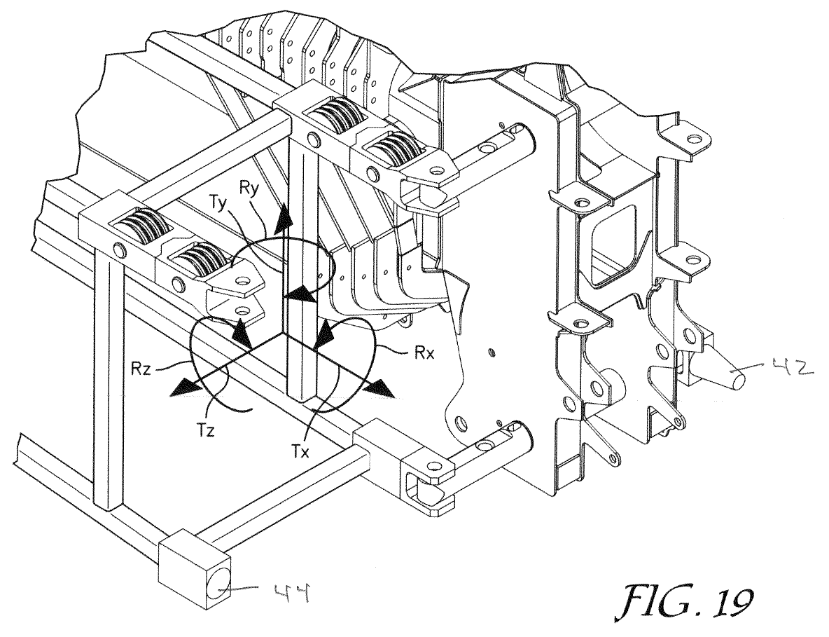

The operation of the disclosed system 10 will now be further detailed. A body in space has six degrees of freedom to include three in translation Tₓ, T_{y}, T_{z} and three in rotation Rx, Ry, Rz as best illustrated in the context of the disclosed system at FIG. 19. To fully constrain a body all six degrees of freedom must be fully constrained. The placement of pins into the attachment points connecting the jib to the boom head requires very precise positioning of the boom head 14 to ensure alignment with the opening in the attachment points 24, 26, 28, 30 of the jib 16. Additionally, the weight of the jib 16 causes the holes for the final pin to be misaligned every time.

The typical means of attaching a jib to the boom head of a crane requires extensive fine adjustments of the location of the boom head which can be manipulated in the three directions of translation; however, to address rotational misalignment of the jib attachment points with the boom head attachment points utilizing current methodologies many times requires the application of considerable manually applied force, e.g., heavy hammers, to drive the pins through the attachment elements on both the boom head 14 and the jib 16.

The disclosed system 10 utilizes mechanical advantage achieved through the application of ropes 200, 202 and sheaves 62, 64, 80, 82 attached to the jib framework 18 to facilitate movement and ultimately alignment of the attachment points of the jib 16 with those of the boom head 14. It is nearly aways a difficult task to install the first two pins connecting the jib 16 to the boom head 14. The fourth pin is also generally quite problematic because the weight and flexure of the jib 16 causes the holes for the final pin to be misaligned every time.

To overcome the misalignment challenges the system 10 as disclosed herein provides a resolution that requires the application of far less manually applied force. As illustrated at FIGS. 5 and 9, the first ends 208 of the ropes 200, 202 are anchored at the jib framework 18 on T-posts 206A. Next the ropes 200, 202 are reeved through the sheave sets 54, 70 with each sheave set comprising two shells 58, 60, 74, 76. As previously discussed, each shell contains four sheaves 62, 64, 80, 82 mounted on axles 66, 68. Consequently, in a preferred embodiment, and purely as exemplary as the number of sheaves may be altered upward or downward, each rope 200, 202 is reeved through a total of eight sheaves prior to exiting the sheave sets 54, 70 for anchorage of the second ends 194, 196 of the ropes 200, 202 to the tubular members 152, 154 within the tensioning members 148, 150.

It is estimated that between 10,000 and 22,000 pounds of force is required to manipulate the final attachment point of a typical jib framework 18 into position for purposes of connection to the boom head 14, depending upon the dimensions of the framework 18 structural members. Different jib configurations require different force levels to accomplish the desired alignment of the jib framework 18. Using an average force of roughly 16,000 pounds required to manipulate the attachment points, the ropes that are reeved through the sheave sets 54, 70 with eight parts of line (there are 8 sheaves per side 50, 52 in this embodiment) will experience 2,000 pounds of tension. If the diameter of the tubular members 152, 154 to which the second ends 194, 196 of the ropes 200, 202 are anchored is 2.5 inches, then 208 ft-lbs of torque is required to rotate the tubular members. The formula for calculating this magnitude of work is as follows:

$$Force multipled by Distance = Torque$$

$$2 , 000 pounds tension ( force ) multiplied by the radius of the tubular member ( {1.2 5}^{″} = 0.104 ft ) = 208 ft - lbs$$

Consequently, a total of 208 ft-lbs of torque applied to the drive shaft 90 and ultimately to the tubular members 152, 154 generates about 2,000 pounds of tension in any one rope 200, 202. If both ropes are to experience 2,000 pounds of tension, then an additional 208 ft-lbs of torque, for a total of 416 ft-lbs, must be applied to the drive shaft 90.

As previously discussed, to adjust the alignment of the jib framework 18, the operator of the system 10 can select the side of the jib framework 18 that requires movement to achieve alignment and slide one or both engagement members 260, 262 of the slip collars into engagement with the toothed drive collars 162, 164 for the side requiring further alignment. Once the slip collars 210, 212 are properly engaged the operator then applies the requisite rotary tool to either the proximal end 98 or the distal end 98A of the worm screw 94 and proceeds to rotate the worm screw to achieve the desired movement to facilitate alignment of the attachment points of the jib framework 18 with the boom head 14.

In a preferred embodiment, the gear reduction supplied by the engagement of the worm screw 94 with the worm gear 92 is 30:1, meaning that for every 30 rotations of the worm screw 94 there is one rotation of the worm gear 92. This 30:1 gear reduction yields a greatly reduced amount of torque that must be supplied at one of the proximal ends 98, 98A of the worm screw 94 to achieve the 208 ft-lbs of torque that will result in the application of 2,000 lbs of tension to one of the two ropes 200, 202. Specifically, the 208 ft-lbs of torque is reduced by a factor of 30 (as the ratio is 30:1). Consequently, to apply 208 ft-lbs of torque to the drive shaft 90 and ultimately to the tubular members 152, 154 to generates about 2,000 lbs of tension in any one rope 200, 202 requires 208 ft-lbs divided by 30 or 6.9 ft-lbs of torque applied at either end 98, 98A of the worm screw 94.

Importantly, as tension is applied to a particular rope or to both ropes 200, 202, the biased retractable pawl assemblies 288, 290 engage with each locking gear 158, 160 to prevent unwinding rotation of the locking gears 158, 160 and a commensurate reduction in tension. Should there be a need to reduce rope tension, a nominal torque can be applied at either end 98, 98A of the worm screw 94 to relieve the applied force acting on the locking gears 158, 160 and the retractable pawl assemblies 288, 290. The operator applies finger or tool pressure to the trough 328 and ledge 330 on the pawl member 310 to retract the locking edge 312 of the pawl member 310 from engagement with the teeth 314 of the locking gears 158, 160.

Once the locking edge 312 is retracted the operator can turn the preferred end 98, 98A of the worm screw 94 manually using a hand tool or a powered tool to achieve the desired range of movement to facilitate alignment of the attachment points, e.g., posts 24, 26, 28, 30, between the jib 16 and the boom head 14. This process can be repeated as necessary to engage one or both sides 50, 52 of the disclosed system 10 to accomplish the attachment of the jib 16 to the boom head 14 without the need to use excessive manually applied force, e.g., a large hammer, to drive the pins into position.

Moreover, the use of the previously referenced cone 42 and socket 44 at one or optionally two of the four attachment points 24, 26, 28, 30 will further accelerate the attachment process and diminish the need for near perfect alignment so that pins that are tightly toleranced to the openings in the attachment points are unneeded. As previously noted, the cone 42 and socket 44 operate to address axial misalignment and are arguably highly functional even when there is slight rotational misalignment. This is the case because the drive assembly 86 and first and second rotatable tensioning members 148, 150 facilitate the desired movement of the attachment points on the jib framework 18 to allow alignment of the attachment points on the jib framework 18 with those on the boom head 14. Additionally, the forces supplied through the rope 200, 202 due to the mechanical advantage provided by the sheaves 62, 64, 80, 82 are considerable and can drive the cone 42 into the socket 44 even though there are still considerable but lesser forces seeking to cause misalignment.

As illustrated at FIG. 19 a body in space has six degrees of freedom, to include three translation Tx, Ty, Tz and three rotation Rx, Ry and Rz. To fully constrain the body all six degrees of freedom must be fully constrained. The top and bottom pins are constrained in all degrees except for Ry which allows the jib 16 to rotate into connection with the boom head 14. The bottom cone 42 and socket joint 44 are constrained at Ty and Tz while the upper rope joint(s) is constrained at Tx, Rx and Rz. By rotating one or both tensioning members 148, 150, through use of the drive assembly 86, the position of the through holes in the upper and lower flanges 39 (FIG. 3) are brought into alignment with the through hole 38 in the post 24. The location of the flanges 39 on the jib framework 18 can be altered through rotation of the appropriate tensioning member 148, 150 which lengthens or shortens the appropriate rope 200, 202 to move the flanges 39 closer to the post 24. Incremental movement of the jib framework 18 upper attachment points serves to reposition the flanges 39 at each attachment point to allow an operator to install a pin through the holes in the flanges 39 and into the openings 38 in the posts 24, 26 without the need for excessive manual effort thereby increasing the efficiency of the jib 16 to boom head 14 connection process and limiting damage to the jib framework 18 and the boom head 14 mounting hardware.

An attribute of the system 10 as disclosed herein is the inherent ability to assist in offsetting of the operational jib which as noted above can be utilized to conveniently assist in alignment of the attachment points on the jib framework 18 with the attachment points on the boom head 14. To offset the jib 16 from the boom head 14 the jib must be fully attached to the boom head. In other words, all attachment points 24, 26, 28, 30 must be secured either by pins or the cone 42 and socket 44 hardware as previously discussed.

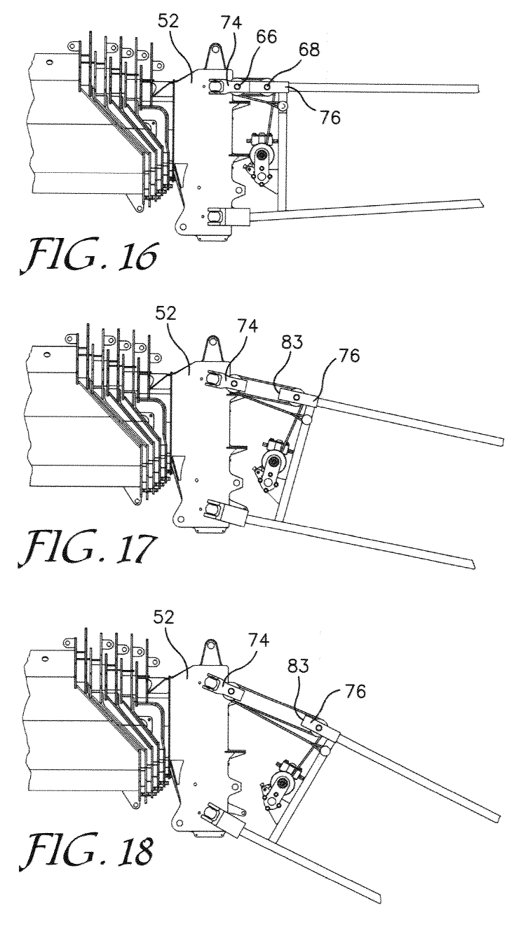

The jib 16 can be offset to accommodate lift scenarios that require the jib to extend not in perfect longitudinal alignment with the extensible sections of the boom as that illustrated at FIG. 16, which reveals a 0-degree offset of the second side 52 of the jib framework. FIG. 16 illustrates how the shells 74, 76 remains together with the interlocking embedded engagement 83 maintaining the alignment between the two shells as best illustrated at FIG. 5. The interlocking embedded engagement 83 as illustrated at FIG. 5 provides that the faces of the two shells 58, 60, 74, 76 that contact each other include an extension on shells 60, 76 and an indentation on shells 58, 74. These extensions and indentations prevent misalignment of the two sets of shells as they engage one another.

FIG. 17 illustrates a 15-degree offset of the jib 16 with the interlocking embedded engagement 83 between the two shells 74, 76 no longer in play. Lastly FIG. 18 illustrates a 30-degree offset of the jib 16 relative to the crane 12. An offset of the jib 16 up to and potentially beyond 30-degrees is accomplished by preliminarily verifying that the amount of rope 200, 202 wrapped around each tensioning member 148, 150 is nearly equivalent, otherwise an attempt to offset the jib, as depicted for example in FIG. 18, will result in the jib 16 being lopsided and forces will be unevenly distributed across the jib framework 18 and the boom head 14.

Once the operator has adjusted the rope wrapped around each tensioning member 148, 150 to ensure that the rope is roughly equivalent, the operator then advances the required engagement members 260, 262 of one or both slip collars 210, 212 into the drive collars 162, 164 thereby ensuring on-demand (as desired by the operator rotating either end 98, 98A of the worm screw 94) rotation of the rotatable tensioning members 148, 150 by the drive shaft 90. Once the slip collars 210, 212 are fully engaged with the drive collars 162, 164 the operator can commence rotation of either drive feature 98, 98A of the worm screw 94 and begin to either unwind rope 200, 202 from the tensioning members 148, 150 to increase the offset angle or alternatively, wind the rope around the tensioning member to reduce the offset angle. Because the offset can be easily increased or decreased with the rotation of the drive assembly 86 this system configuration offers significant time savings and greatly reduces the level of physical exertion required over prior designs.

Benefits, other advantages, and solutions to problems have been described herein regarding specific embodiments. However, the benefits, advantages, solutions to problems, and any element or combination of elements that may cause any benefits, advantage, or solution to occur or become more pronounced are not to be considered as critical, required, or essential features or elements of any or all the claims of at least one invention.

Many changes and modifications within the scope of the instant disclosure may be made without departing from the spirit thereof, and the one or more inventions described herein include all such modifications. Corresponding structures, materials, acts, and equivalents of all elements in the claims are intended to include any structure, material, or acts for performing the functions in combination with other claim elements as specifically recited. The scope of the one or more inventions should be determined by the appended claims and their legal equivalents, rather than by the examples set forth herein.

Benefits, other advantages, and solutions to problems have been described herein regarding specific embodiments. Furthermore, the connecting lines, if any, shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

In the detailed description herein, references to “one embodiment,” “an embodiment,” “an example embodiment,” etc., indicate that the embodiment described may include a feature, structure, or characteristic, but every embodiment may not necessarily include the feature, structure, or characteristic. Moreover, such phrases are not necessarily referring to the same embodiment. Further, when a feature, structure, or characteristic is described relating to an embodiment, it is submitted that it is within the knowledge of one skilled in the art to affect such feature, structure, or characteristic relating to other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The invention has been described above with reference to one or more preferred embodiments, it will be appreciated that various changes or modifications may be made without departing from the scope of the invention as defined in the appended claims.

We claim:

1. A system for attachment of a jib to a crane, the system comprising:
a boom head, the boom head disposed at a distal end of the crane and comprising a plurality of primary attachment points;
a jib framework, the jib framework comprising a first and second side and a plurality of secondary attachment points, the secondary attachment points operable for securing the first and second sides of the jib framework to the primary attachment points of the boom head;
a first and second set of sheaves with each set of sheaves disposed respectively within a first and second shell with the first and second shells replicated on the first and second sides of the jib framework;
at least one rope reeved through the first and second set of sheaves on each side of the jib framework to increase the mechanical advantage available to the system on both sides, each of the ropes comprising a first end and a second end, the first ends of each rope anchored to the jib framework;
a drive assembly for rotating a drive shaft extending between the first and second sides of the jib framework, the drive shaft comprising a first and second end; and
first and second opposed rotatable tensioning members, the rotatable tensioning members coaxial with the axis of rotation of the drive shaft, disposed outwardly from the drive assembly and each comprising a first and second end, the first end of each rotatable tensioning member rotatably mounted to the jib framework, the second end of each rotatable tensioning member comprising a drive member to facilitate engagement with the rotary motion of the drive shaft; and
first and second slip collars independently operable to selectively transfer rotational motion from the drive shaft to the respective drive member for rotation of the rotatable tensioning member to which the second end of the rope is attached for purposes of adjusting the tension in the rope and repositioning the secondary attachment points of the jib framework.

2. The system of claim 1, wherein at least one primary attachment point on the boom head comprises a cone.

3. The system of claim 2, wherein the cone is operable for off-center receipt into a conically shaped opening in a mounting block at a secondary attachment point on the jib framework.

4. The system of claim 1, wherein the jib comprises at least four longitudinally extending chord members extending outwardly from the jib framework.

5. The system of claim 1, wherein each shell comprises an axle extending between two laterally opposed retaining walls and in the range of 2 to 6 sheaves mounted per axle.

6. The system of claim 1, wherein the drive assembly comprises a worm screw rotating a worm gear, the worm gear mounted to the drive shaft.

7. The system of claim 6, wherein a drive lug extends outwardly from both a first end and a second end of the worm screw for engagement with a rotary tool.

8. The system of claim 1, wherein the first and second cylindrically shaped slip collars each comprise first and second holes separated by approximately 180 degrees.

9. The system of claim 8, wherein the first end of each slip collar further comprises a plurality of circumferentially disposed engagement members.

10. The system of claim 9, wherein a pin extends through the first hole of each slip collar, through a longitudinally extending slot in the drive shaft and finally through the second hole of each slip collar, thereby allowing longitudinal traverse of each slip collar along the rotational axis of the drive shaft for mating engagement of the circumferentially disposed engagement members with a toothed drive collar that in turn is secured to a locking gear mounted to the respective rotatable tensioning members, the slip collar and pin combination are operable to transfer rotational motion from the drive shaft to the respective rotatable tensioning member and ultimately to the at least one reeved rope that is anchored to the rotatable tensioning member.

11. The system of claim 10, wherein rotation of the locking gear is prevented through engagement of a biased retractable pawl with circumferentially disposed teeth of the locking gear.

12. The system of claim 11, wherein the biased retractable pawl is mounted to a primary support member extending between the first and second sides of the jib framework.

13. The system of claim 12, wherein the rotatable tensioning members and coaxially disposed drive shaft are supported by at least one flange member extending outwardly from the primary support member.

14. The system of claim 10, wherein rotation of the drive assembly results in rotation of the drive shaft, slip collar engaged with the toothed drive collar, associated locking gear and rotatable tensioning member thereby allowing independent adjustment of the position of the second shells on each side of the jib framework.

15. A system for aligning a jib for attachment to a crane, the system comprising:
a boom head of the crane, the boom head comprising a plurality of primary attachment points;
a jib framework, the jib framework comprising a first and second side and a plurality of secondary attachment points for securing the first and second sides of the jib framework to the boom head primary attachment points;
first and second shells with a plurality of axle mounted sheaves disposed therein, the shells and axle mounted sheaves disposed on both the first and second sides of the jib framework;
a first rope with a first end and a second end, the first rope reeved through the first shell and axle mounted sheaves with the first end anchored to the jib framework and the second end anchored to a first rotatable tensioning member;
a second rope with a first end and a second end, the second rope reeved through the second shell and axle mounted sheaves with the first end anchored to the jib framework and the second end anchored to a second rotatable tensioning member; and
a drive assembly for independently adjusting tension applied to the first and second reeved ropes through rotation of the rotatable tensioning members thereby repositioning the secondary attachment points of the jib framework for alignment with the primary attachment points of the boom head.

16. The system of claim 15, wherein a pair of upper secondary attachment points on the first and second sides of the jib framework each comprise an upper flange spaced apart from a lower flange with a through hole in both the upper and lower flanges for receiving a pin.

17. The system of claim 16, wherein the plurality of primary attachment points each with a through hole therein extend laterally outward from the boom head and are received into the space between the upper and lower flanges.

18. The system of claim 17, wherein the pin is received into the through hole in the upper flange then into the through hole in the primary attachment point and finally into the through hole in the lower flange.

19. The system of claim 18, wherein at least one lower secondary attachment point on the jib framework comprises a socket with a conically shaped volume removed from the lower secondary attachment point.

20. The system of claim 19, wherein at least one lower primary attachment point on the boom head comprises a conically shaped member that is secured to one of the rotatable attachment members, the conically shaped member operable for receipt into the socket.

21. The system of claim 15, wherein four sheaves are disposed within each of the first and second shells on each side of the jib framework resulting in a reduction in the tension of the rope anchored to the rotatable tensioning members.

22. The system of claim 15, wherein the drive assembly comprises a worm screw for rotating a worm gear, a first end and a second end of the worm screw operable for connection to a rotary tool.

23. The system of claim 22, wherein the worm gear is mounted to the drive shaft.
